(19) United States
(12) Patent Application Publication
(10) Pub. No.: US 2026/0356673 A1
(43) Pub. Date: Nov. 12, 2026

(54) REAGENTS AND PROCESSES FOR REMOVING HEAVY METALS FROM PHOSPHORIC ACID SOLUTIONS

(71) Applicant: Cytec Industries Inc., Lawrence, NJ (US)

(72) Inventors: Lei Zhang, Stamford, CT (US); Ravi Rajshekar Hiremath, Milford, CT (US); Kewei Wang, Shanghai (CN); Kenan Tokmic, New Hope, PA (US)

(73) Assignees: Cytec Industries Inc., Princeton, NJ (US); Cytec Industries Inc., Lawrence, NJ (US)

(21) Appl. No.: 19/108,075

(22) PCT Filed: Sep. 1, 2023
(86) PCT No.: PCT/EP2023/074029

§ 371 Date: Feb. 28, 2025

Related U.S. Application Data
(60) Provisional application No. 63/403,326, filed on Sep. 2, 2022.

(51) Int. Cl. C01B 25/238

(52) U.S. Cl. CPC C01B 25/238; C01P 2006/80

(57) ABSTRACT

Processes for removing heavy metal ions in phosphoric acid mixtures by adding an effective amount of reagents comprising a plurality of sulfur groups to the phosphoric acid mixture to form heavy metal complexes, and separating the heavy metal complexes from the solution are provided herein.

### FIELD OF THE INVENTION

The present invention generally relates to purification in industrial process streams. More particularly, the present invention relates to removing heavy metal ions from phosphoric acid process streams.

### DESCRIPTION OF THE RELATED ART

About 90% of the world's phosphoric acid is produced according to the wet process, which is conventionally prepared by acidulating phosphate rock (which contains calcium phosphate) with sulfuric acid to yield a crude wet-process phosphoric acid (WPA) and insoluble calcium sulfate (gypsum).

The manufacture of phosphoric acid is well known and is the subject of numerous textbooks. An overall view of the manufacture of phosphates and phosphoric acid is treated by Becker in Phosphates and Phosphoric Acids, Marcel Dekker, Inc. 1989; and by Stack in Phosphoric Acid, Part 1 and Part 2, Marcel Dekker, Inc. 1968. In the process, phosphate rocks are cleaned in the wash plant and ground in the Ball mill before being fed into a series of reactors for digestion with sulfuric acid along with recycled phosphoric acid from the process. After digestion, the reaction slurry is filtered to separate phosphoric acid from undissolved rocks, the newly formed gypsum, and the gangues. The filtered crude WPA is then sent to clarifiers and evaporators for further purification and concentration. The purified phosphoric acid is either sent out as Merchant Grade Acid (MGA) or continued to make 69% P₂O₅ Super Phosphoric Acid (SPA), where it can be converted to many end products ranging from a chemical reagent, rust inhibitor, food additive, dental and orthopedic etchant, electrolyte, flux, dispersing agent, industrial etchant, fertilizer feedstock, and component of home cleaning products. For example, crude phosphoric acid is concentrated to 54% (P₂O₅) before sent for Monoammonium Phosphate (MAP), Diammonium Phosphate (DAP), or ammonium phosphate-sulfate (APS) production.

During the production of phosphoric acid certain metal impurities in the form of heavy metal ions, such as cadmium, copper, arsenic, lead, and mercury, are present as minerals in the phosphate rock and are dissolved into the phosphoric acid. The metal impurities are considered unacceptable above a certain level, depending on the application of the phosphoric acid, because of their toxicity. Accordingly, the metal impurities have to be either completely removed or their levels have to be significantly reduced.

For example, cadmium (Cd) is toxic and can cause multiple issues to human beings' health. Studies show that the major exposure of Cd to nonsmoking general population is through ingestion of contaminated food. Phosphate fertilizers have been identified as an important source that introduces Cd to the soil, which can be easily absorbed by agricultural plants and accumulated into the food chain (“Cadmium in phosphate fertilizers; ecological and economical aspects”, CHEMIK 2014, 68, 10, 837-842).

Cd in phosphate fertilizer comes from phosphoric acid, the major raw material used to produce phosphate fertilizer. In fact, the majority of phosphoric acid production is used to produce fertilizer. Cd in phosphoric acid further stems from the phosphate bearing ores. Therefore, Cd can be removed either from the phosphate ore or from the phosphoric acid stream, with the latter being the focus of research in the past decades. Several categories of technologies to remove Cd from acid stream have been developed, including co-crystallization with anhydrite, precipitation with sulfide ions and organic sulfurous compounds, removal by solvent extraction, removal by ion exchange, removal by adsorbents, and separation by membrane technology (“Progress in the development of decadmiation of phosphorus fertilizers” Fertilizer Industry Federation of Australia, Inc., Conference “Fertilizers in Focus”, 2001, 101-106).

U.S. Pat. No. 4,378,340 (1983) discloses a method of removing heavy metals, particularly cadmium, from wet process phosphoric acid through partial neutralization of acids with alkali, followed by precipitation with sulfide compounds. U.S. Pat. No. 5,431,895 (1995) also discloses using alkali solution and aqueous sulfide solution simultaneously with thorough mixing to remove lead and cadmium from phosphoric acid.

U.S. Pat. No. 4,986,970 (1991) discloses using metal salt of dithio carbonic acid-O-esters to precipitate the heavy metals, especially cadmium, from partially neutralized (pH 1.4-2) and pre-cooled (5-40 °C) phosphoric acid. Afterwards, the complexes can be separated from the acid using methods like flotation or filtration. U.S. Pat. No. 4,452,768 (1984), U.S. Pat. No. 4,479,924 (1984), U.S. Pat. No. 4,713,229 (1987), and European Patent No. EP0333489 B1 (1989) disclose methods of separating heavy metals, especially cadmium, mercury, and lead, from phosphoric acid using a diorganyldithiophosphoric acid ester and an adsorbent, a diorganyldithiophosphorus compound and an adsorbent, a diorganyldithiophosphoric acid ester and an adsorbent and a reductant, and a thioorganophosphine reagent and a reducing agent, respectively. U.S. Patent Publication No. 2004/0179984 also discloses methods of removing heavy metals from wet process phosphoric acid by adding a mixture reagents of diorgano dithiophosphinic acid (or alkali metal or ammonia salts thereof), a first dithiophosphoric acid (or alkali metal or ammonia salts thereof) with alkyl or alkylaryl or aralkyl moieties, and optionally a second diaryl dithiophosphoric acid (or alkali metal or ammonia salts thereof).

Several scientific publications (“Cadmium(II) extraction from phosphoric media by bis(2,4,4-trimethylpentyl) thiophosphinic acid (Cyanex 302),” Fluid Phase Equilibria 145 (1998) 301-310), and “Extraction of cadmium from phosphoric acid by trioctylphosphine oxide/kerosene solvent using factorial design,” Periodica Polytechnic Chemical Engineering 55/2 (2011) 45-48)) discuss removal of Cadmium from phosphoric acid based on solvent extraction method using reagents such as bis(2,4,4-trimethylpentyl) thiophosphinic acid/kerosene, and trioctylphosphine oxide/kerosene, respectively.

### SUMMARY OF THE INVENTION

While the various reagents and approaches discussed above may have some merits and applicability in phosphoric acid production, the high investment cost, high treatment cost, and low efficacy are limiting their wide acceptance at the plant scale (See “Cadmium in phosphate fertilizers; ecological and economical aspects”, CHEMIK 2014, 68, 10, 837-842). Heavy metal contamination of food, especially cadmium that stems from use of phosphoric acid in fertilizer production, continues to be a concern to public health. The economic impact for the issue of heavy metal is substantial, and the industry is in need of a more efficient and economical technology than that which currently exists. Additionally, there has been a recent regulatory push to further limit the Cd level in phosphate fertilizers (See European Commission Fact Sheet. “Circular economy: New Regulation to boost the use of organic and waste-based fertilisers.” EU MEMO-16-826, 17 Mar. 2016, europa.eu/rapid/press-release_MEMO-16-826_en.htm).

Accordingly, the compositions and methods presently available for heavy metal removal from phosphoric acid in the production process require further improvement. Since many factors (e.g., ore type, temperature, agitation, reactor design, acid chemistry, foreign ions, organic species, and viscosity of phosphoric acid medium) can affect the performance of reagents, it is a great challenge to develop high-efficiency reagents useful for removing heavy metals from phosphoric acid. Successful reagents for removing heavy metals in industrial process streams such as wet process phosphoric acid would be a useful advance in the art and could find rapid acceptance in the industry.

In view of the forgoing problems and challenges in the field, the inventors describe herein, in various embodiments, their surprising discovery that certain heavy metal chelating agents comprising a plurality of sulfur groups are effective in reagents useful for removing heavy metal ions from aqueous solutions containing phosphoric acid. In various embodiments, heavy metal chelating agents can include 2,5-Dimercapto-1,3,4-thiadiazole, 2,3-Dimercapto-1-propanol, a thio-containing polymer, derivatives thereof, and mixtures thereof. Accordingly, the processes for removing heavy metal ions according to various embodiments of the present invention as described herein are applicable for use with the various stages of wet process phosphoric acid production.

Accordingly, in one aspect provided herein are processes for removing heavy metal ions from a solution containing phosphoric acid by adding an effective amount of a reagent including a heavy metal chelating agent comprising plurality of sulfur groups to the solution to form heavy metal precipitates and/or complexes and separating the heavy metal precipitates and/or complexes from the solution.

In the same or additional embodiments, the process can further include adding an effective amount of organothiophosphorus compounds to the solution containing phosphoric acid.

This summary does not list all necessary characteristics and, therefore, subcombinations of these characteristics or elements may also constitute an invention. Accordingly, these and other objects, features and advantages of this invention will become apparent from the following detailed description of the various embodiments of the invention taken in conjunction with the accompanying Figures and Examples.

### BRIEF DESCRIPTION OF THE DRAWINGS

FIG. 1 is a graph illustrating the results of Examples 1A & 1J-1 to 1J-5, showing the percentage of As removed from the plant weak phosphoric acid at ~75 °C with dosages of heavy metal chelating agent 2,3-dimercapto-1-proanol (“DTG”) at 0 to 4 kg/T P₂O₅ level;

FIG. 2 is a graph illustrating the results of Examples 1C-1, 1K-1, 1K-3, 1K-4 & 1K-5, showing the percentage of Cd removed from the plant weak phosphoric acid at ~75 °C with dosages of heavy metal chelating agent DTG at 0 to 4 kg/T P₂O₅ level and a subsequent dosage of sodium diisobutyl dithiophosphinate (“Na-DTPi”) at 0.5 kg/T P₂O₅ level;

FIG. 3 is a graph illustrating the results of Examples 2A & 2B-1 to 2B-4, showing the percentage of heavy metal removed from the digestion slurry of phosphoric acid at ~80 °C with dosages of heavy metal chelating agent 2,5-dimercapto-1,3,4-thiadiazole dipotassium salt (“DMTD-2K”) at 0 to 9 kg/T P₂O₅ level;

FIG. 4 is a graph illustrating the results of Examples 3A & 3B-1 to 3B-4, showing the percentage of heavy metal removed from the concentrated plant phosphoric acid at ~70 °C with dosages of heavy metal chelating agent DMTD-2K at 0 to 4 kg/T P₂O₅ level;

FIG. 5 is a graph illustrating the results of Examples 3E-1, 3C-2, & 3F-1, showing the percentage of Cd removed from the concentrated plant phosphoric acid at ~70 °C with various dosages of heavy metal chelating agent DTG and Na-DTPi; and

FIG. 6 is a graph illustrating the results of Examples 4A & 4B-1 to 4B-4, showing the percentage of heavy metal removed from the concentrated plant phosphoric acid at ~70 °C with dosages of heavy metal chelating agent comprising polyamine/alkyl glycidyl ether/(glycidyloxypropy)trimethoxysilane/(mercaptopropyl)trimethoxysilane (“P1”) at 0 to 10 kg/T P₂O₅ level.

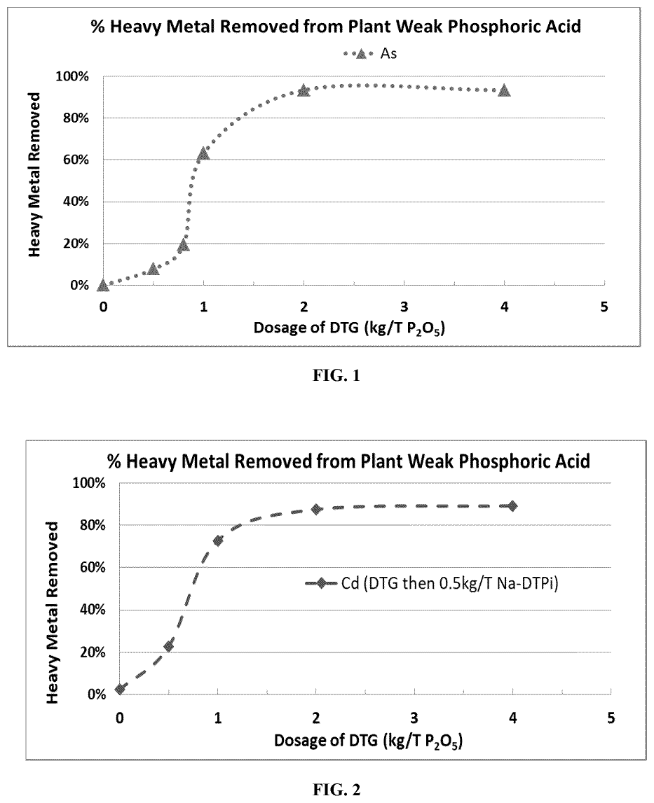

### DETAILED DESCRIPTION OF CERTAIN EMBODIMENTS OF THE INVENTION

The present invention generally relates to purification of solutions in industrial process streams. More particularly, the inventors describe herein for the first time processes for removing and/or recovering heavy metal ions from solutions containing phosphoric acid by adding an effective amount of a reagent comprising a heavy metal chelating agent having a plurality of sulfur groups to the solution. The compositions and processes described herein provide improvement and/or an unexpected advantage when compared to the prior art processes and compositions. As employed throughout the disclosure of the invention, the following terms are provided to assist the reader. Unless otherwise defined, all terms of art, notations and other scientific or industrial terms or terminology used herein are intended to have the meanings commonly understood by those of skill in the chemical and/or phosphoric acid production arts. In some cases, terms with commonly understood meanings are defined herein for clarity and/or for ready reference, and the inclusion of such definitions herein should not necessarily be construed to represent a substantial difference over the definition of the term as generally understood in the art unless otherwise indicated. As used herein and in the appended claims, the singular forms include plural referents unless the context clearly dictates otherwise. Throughout this specification, the terms retain their definitions.

As used herein with reference to the present invention, the term “heavy metal” or “metal” shall refer to those elements of the periodic table having a density of more than 5 g/cm³ and an oxidation state higher than 0, (i.e., heavy metal ions). Such heavy metal ions include, for example, one or more of copper (Cu), cadmium (Cd), nickel (Ni), mercury (Hg), zinc (Zn), arsenic (As), manganese (Mn) and lead (Pb). In any or all embodiments, cadmium ions and arsenic ions can be removed from solutions containing phosphoric acid.

As used herein, the term “heavy metal chelating agent” generally refers to any such compound that interacts, reacts, or binds with heavy metal ions to form a “heavy metal complex”. Heavy metal chelating agents as described herein include a plurality of sulfur groups. More preferred heavy metal chelating agents according to the invention are described herein. Heavy metal complexes can be solid, waxy, or oily in the phosphoric acid solutions. They can precipitate, float, or suspend in the phosphoric acid solutions.

Those skilled in the art will understand that reference to “phosphoric acid solutions,” or “solutions containing phosphoric acid,” in the context of the invention includes any aqueous acidic solution or mixture containing crude phosphoric acid, digestion slurries, filtered acid, and/or concentrated acid.

“Effective amount” means the dosage of any of the reagents disclosed herein on an active basis necessary to provide the desired performance in the phosphoric acid system or circuit being treated (such as the formation of heavy metal complexes) when compared to an untreated control system or system using a reagent product of the prior art.

The term “hydrocarbyl” is a generic term encompassing aliphatic, alicyclic and aromatic groups having an all-carbon backbone and consisting of carbon and hydrogen atoms. In certain cases, as defined herein, one or more of the carbon atoms making up the carbon backbone may be replaced or interrupted by a specified atom or group of atoms, such as by one or more heteroatom of N, O, and/or S. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, aralkenyl and aralkynyl groups. Recitation or discussion of such hydrocarbyl groups includes their substituted or unsubstituted forms. This concept is sometimes phrased as “optionally substituted.” When substituted, it can be by one or more substituents as defined herein elsewhere. The examples and preferences expressed below also apply to each of the hydrocarbyl substituent groups or hydrocarbyl-containing substituent groups referred to in the various definitions of substituents for compounds of the formulas described herein unless the context indicates otherwise.

Preferred non-aromatic hydrocarbyl groups are saturated groups such as alkyl and cycloalkyl groups. Generally, and by way of example, the hydrocarbyl groups can have up to fifty carbon atoms, unless the context requires otherwise. Hydrocarbyl groups with from 1 to 30 carbon atoms are preferred. Within the sub-set of hydrocarbyl groups having 1 to 30 carbon atoms, particular examples are C₁₋₂₀ hydrocarbyl groups, such as C₁₋₁₂ hydrocarbyl groups (e.g., C₁₋₆ hydrocarbyl groups or C₁₋₄ hydrocarbyl groups), specific examples being any individual value or combination of values selected from C₁ through C₃₀ hydrocarbyl groups.

As used herein, the term “alkyl” is intended to include linear, branched, or cyclic hydrocarbon structures and combinations thereof. Preferred alkyl groups are those of C₃₀ or below. Lower alkyl refers to alkyl groups of from 1 to 8 carbon atoms. Examples of lower alkyl groups include methyl, ethyl, propyl, isopropyl, butyl, s- and t-butyl, pentyl, hexyl, octyl and the like. Cycloalkyl is a subset of alkyl and includes cyclic hydrocarbon groups having from 3 to 30 carbon atoms, preferably from 3 to 8 carbon atoms as well as polycyclic hydrocarbons having 7 to 10 carbon atoms.

The term “aryl” as used herein refers to cyclic (mono or multi-cyclic), aromatic hydrocarbons that do not contain heteroatoms in the ring portion. In any or all embodiments, aryl groups contain from 6 to 14 carbons in the ring portions of the groups. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those known to persons of skill in the art. Aryl groups of C₆-C₁₂ are preferred. The term “aralkyl” as used herein is a broad term and is used in its ordinary sense, including, without limitation, to refer to an alkyl having at least one alkyl hydrogen atom replaced with an aryl moiety, such as benzyl, —CH₂(1 or 2-naphthyl), —(CH₂)₂phenyl, —(CH₂)₃phenyl, —CH(phenyl)₂, and the like. Particularly preferred are C₇₋₂₀ aralkyl groups. In any or all embodiments, one or both alkyl and aryl may be optionally substituted with one or more ubstituents as described herein elsewhere.

Substituted hydrocarbyl groups, e.g., alkyl, aryl, aralkyl, cycloalkyl, alkoxy, etc., refer to the specific substituent wherein up to three H atoms in each residue are replaced with alkyl, halogen, haloalkyl, hydroxy, alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, halobenzyl, heteroaryl, phenoxy, benzyloxy, heteroaryloxy, benzoyl, halobenzoyl, or lower alkylhydroxy. In certain cases, as defined herein, one or more of the carbon atoms making up the carbon backbone may be replaced or interrupted by a specified atom or group of atoms, such as by one or more heteroatom of N, O, and/or S.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In any or all embodiments, the term “about” or “approximately” means within 50%, 30%, 25%, 20%, 15%, 10%, 9%, 8%, 7%, 6%, 5%, 4%, 3%, 2%, 1%, 0.5%, 0.1%, or 0.05% of a given value or range.

The term “plurality” as used herein includes a quantity of two or more of the thing that the term modifies or describes. For example, a heavy metal chelating agent having a plurality of sulfur groups refers to a compound that performs as a chelator of heavy metals and has two or more sulfur groups. The terms “sulfur groups” or “sulfur group” as used herein can refer to thiols, thiolates, or sulfur atoms present in a ring system of a compound as hetero atoms.

The terms “comprised of,” “comprising,” or “comprises” as used herein includes embodiments “consisting essentially of” or “consisting of” the listed elements, and the terms “including” or “having” in context of describing the invention should be equated with “comprising”.

Those skilled in the art will appreciate that while preferred embodiments are discussed in more detail below, multiple embodiments of the reagent system and processes described herein are contemplated as being within the scope of the present invention. Thus, it should be noted that any feature described with respect to one aspect or one embodiment of the invention is interchangeable and/or combinable with another aspect or embodiment of the invention unless otherwise stated.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group consisting of any two or more of the explicitly listed elements, components, or features. Additionally, any element, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. The term “et seq.” is sometimes used to denote the numbers subsumed within the recited range without explicitly reciting all the numbers, and should be considered a full disclosure of all the numbers in the range. Disclosure of a narrower range or more specific group in addition to a broader range or larger group is not a disclaimer of the broader range or larger group.

In various embodiments, it is surprisingly discovered that certain heavy metal chelating agents comprising plurality of sulfur groups are effective in reagents useful for removing heavy metal ions from aqueous solutions containing phosphoric acid. In some embodiments, 2,5-Dimercapto-1,3,4-thiadiazole; 2,3-Dimercapto-1-propanol; thio-containing polymers; derivatives thereof, and mixtures thereof can be used in reagents useful for removing heavy metal ions from aqueous solutions containing phosphoric acid.

In some embodiments, heavy metal chelating agents having a plurality of sulfur groups can be used with a surfactant. In some embodiments, a surfactant can be added with 2,5-Dimercapto-1,3,4-thiadiazole; 2,3-Dimercapto-1-propanol, a thio-containing polymer; derivatives thereof, and mixtures thereof. The surfactant compound can be selected from the group consisting of sulfosuccinates; arylsulfonates; alkarylsulfonates; diphenyl sulfonates; olefin sulfonates; sulfonates of ethoxylated alcohols; petroleum sulfonates; sulfosuccinamates; alkoxylated surfactants; ester/amide surfactants; EO/PO block copolymers; and mixtures thereof. In a preferred embodiment, the surfactant can be a sulfosuccinate. In the same or alternate embodiment, the sulfosuccinate can be sodium dioctylsulfosuccinate. Suitable sodium dioctylsulfosuccinate compounds include, but are not limited to, AEROSOL® OT-70 and DHAYSULF® 70B available from Solvay S.A. Suitable alkoxylated surfactants can include, but are not limited to, polyethyleneglycol sorbitan monooleate (such as TWEEN® 80 available from Croda), and polyethyleneglycol sorbitol hexaoleate (such as ATLAS® G1086 available from Croda).

In any or all embodiments of the invention, 2,5-Dimercapto-1,3,4-thiadiazole, 2,3-Dimercapto-1-propanol, a thio-containing polymer, derivatives thereof, and mixtures thereof can be added to either the crude acid or digestion slurries prior to gypsum filtration, or to the filtered acid or the concentrated acid to complex the heavy metals. Afterwards, heavy metal complexes can be separated from the acid or slurry. In any or all embodiments, the methods of separation include, but are not limited to, filtration, centrifugation, sedimentation, creaming, flocculation, adsorption, and/or flotation.

In any or all embodiments of the invention, 2,5-Dimercapto-1,3,4-thiadiazole, 2,3-Dimercapto-1-propanol, a thio-containing polymer, derivatives thereof, and mixtures thereof can be added to the solution containing phosphoric acid all in one stage or added in several stages. In the same or other embodiments, 2,5-Dimercapto-1,3,4-thiadiazole, 2,3-Dimercapto-1-propanol, a thio-containing polymer, derivatives thereof; and mixtures thereof can be added as a blend, or separately in any order such as concurrently together or sequentially. Treatment times in various embodiments can be from a few seconds (i.e., 5 to 10 seconds) to 24 hours. In those instances where the reagent complexes the heavy metals very rapidly, the preferred treatment times are from about 5 seconds to 3 hours. Most typically, the treatment times are from 10 seconds to 60 seconds or 120 seconds.

The dosage of the reagent for complexing heavy metals and removal efficiency for the various heavy metals will depend on the amount of heavy metal impurities present in the ore and/or solution containing phosphoric acid. Generally, the greater number of heavy metals present and the higher their concentrations, the greater will be the overall dosage of the reagent. Those skilled in the art will be able to readily determine and establish the optimum dosage of 2,5-Dimercapto-1,3,4-thiadiazole, 2,3-Dimercapto-1-propanol, a thio-containing polymer, derivatives thereof, and mixtures thereof required using no more than routine experimentation. Generally, the dosages may be in the range of from 0.01 to 50 kg (e.g., 0.01, 0.02, 0.03, 0.04, 0.05, et seq. to 0.10, 0.15, 0.20, 0.25, 0.30, et seq. to 1.0, 1.5, 2.0, 2.5, 3.0, 3.5, 4.0, 4.5, 5.0, et seq. to 10, 15, 20, 25, 30, 35, 40, 45, 50 kg) reagent per ton of P₂O₅ of the phosphoric acid solution, based on the type of heavy metal ions to be removed. Most typically, the dosages can be from 0.1 kg to 10 kg (e.g., 0.10, 0.15, 0.20, 0.25, 0.30, et seq. to 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, and 10 kg) of reagent per ton of P₂O₅. It will be understood by those ordinarily skilled in the art that any of the recited dosages (except the lowest dosage point) can also be recited as “less than” a particular dosage, e.g., less than 50 kg; or that any of the recited dosages (except the highest dosage point) can also be recited as “greater than” a particular dosage, e.g., greater than 0.10 kg.

In embodiments where surfactant is added, the ratio of heavy metal chelating agents comprising a plurality of sulfur groups to surfactant is, in some embodiments, from 1 to 2 to 100 to 1. In some embodiments where surfactant is added, the ratio of heavy metal chelating agents comprising a plurality of sulfur groups to surfactant is from 2:1 to 50:1.

In any or all embodiments, the solution containing phosphoric acid has a P₂O₅ concentration from 1 wt. % to 70 wt. %. In some embodiments, the solution containing phosphoric acid has a P₂O₅ concentration from 20 wt. % to 70 wt. %. Specific concentrations of P₂O₅ contemplated for use with the invention include 24 wt. %, 25 wt. %, 26 wt. %, 28 wt. %, 30 wt. %, 42 wt. %, 48 wt. %, 52 wt. %, 56 wt. % 60 wt. % and 69 wt. %.

The compositions and processes described herewith as the present invention can be used over a wide temperature range. In any or all embodiments, for example, the processes according to the invention can be performed at a temperature from 0 °C to 120 °C. Preferably, the temperature is in the range from 10 °C to 80 °C. In any or all of the embodiments according to the present invention, the process can further include adding an effective amount of a reducing agent and/or an adsorbent agent to the solution containing phosphoric acid. Such agents are known to be useful in the field. In certain circumstances one or both of these agents can enhance the activity of the reagent comprising heavy metal chelating agents comprising a plurality of sulfur groups in reagents useful for removing heavy metal ions from aqueous solutions containing phosphoric acid as described herein.

In some embodiments one or both of these agents can enhance the activity of reagents including 2,5-Dimercapto-1,3,4-thiadiazole, 2,3-Dimercapto-1-propanol, a thio-containing polymer, derivatives thereof, and mixtures. In the same or alternate embodiments, the reducing and/or adsorbent agent can be added to the solution containing phosphoric acid all in one stage or added in several stages. In the same or other embodiments, the reducing and/or adsorbent agent can be added together as a blend with the reagent comprising heavy metal chelating agents comprising plurality of sulfur groups in reagents useful for removing heavy metal ions from aqueous solutions containing phosphoric acid as described herein. In some embodiments the reducing and/or adsorbent agent can be added together as a blend with the reagent including 2,5-Dimercapto-1,3,4-thiadiazole, 2,3-Dimercapto-1-propanol, a thio-containing polymer, derivatives thereof, and mixtures, or separately in any order with 2,5-Dimercapto-1,3,4-thiadiazole, 2,3-Dimercapto-1-propanol, a thio-containing polymer, derivatives thereof, and mixtures such as concurrently together or sequentially. While the nature and quantity of the reducing and/or adsorbent agents used depends on the particular composition of the phosphoric acid in the solution, and of the purity specifications, those skilled in the art will be able to determine the optimum dosage range using no more than routine experimentation.

Reducing agents useful in any or all processes according to the invention include, but are not limited to, iron powder, zinc, red phosphorus, iron (II) sulfate, sodium hypophosphite, hydrazine, hydroxymethane sulfonate, and mixtures thereof. In preferred embodiments, the reducing agent includes sodium hypophosphite. In any or all embodiments, the reducing agent is used in an amount from 0.01 kg to 50 kg of reagent per ton of P₂O₅, based on the type and quantity of the oxidants in the phosphoric acid solution, which can be readily determined by those skilled in the art using no more than routine methods. In preferred embodiments, the amount of reducing agent is from 0.1 kg to 5 kg of reagent per ton of P₂O₅ of the phosphoric acid solution.

Adsorbent agents useful in any or all embodiments according to the invention include all those substances that are capable of adsorbing at their surface a sufficiently large quantity of the chelation products of heavy metal ions with 2,5-Dimercapto-1,3,4-thiadiazole, 2,3-Dimercapto-1-propanol, a thio-containing polymer, derivatives thereof, and mixtures. Such compounds include, but are not limited to, active charcoal/carbon, carbon black, ground lignite, adsorbents containing silicate (e.g., synthetic silicic acids, zeolites, calcium silicate, bentonite, perlite, diatomaceous earth, and fluorosilicate), calcium sulfate (including gypsum, hemihydrate, and anhydride), and mixtures thereof. In any or all embodiments, the adsorbent is present in an amount from 0.05 wt. % to 50 wt. %, and preferably from 0.1 wt. % to 5 wt. %, based on the quantity of phosphoric acid in the solution.

While various embodiments may have been described herein in singular fashion, those skilled in the art will recognize that any of the embodiments described herein can be combined in the collective. The invention includes at least the following embodiments:

Disclosed herein, in certain embodiments, is a process for removing heavy metal ions from a phosphoric acid mixture, the process comprising adding to the phosphoric acid mixture an effective amount of a reagent comprising a heavy metal chelating agent comprising a plurality of sulfur groups. In some embodiments, the phosphoric acid mixture is a solution. In some embodiments, the phosphoric acid mixture is a slurry. In some embodiments, the heavy metal the heavy metal ion can be selected from the group consisting of cadmium, copper, arsenic, mercury, lead, and mixtures of any of the foregoing. In some embodiments, the heavy metal ion is cadmium. In some embodiments, the heavy metal ion is arsenic.

In some embodiments, the heavy metal chelating agent having a plurality of sulfur groups is selected from a compound according to Formulas I(A) or I(B):

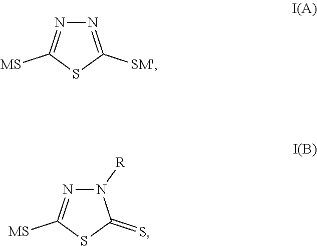

and salts thereof,
wherein each M and M′ of Formula I(A) or I(B) is independently chosen from H, Na, K, Li, NH₄, NR′₄, wherein each R′ is independently chosen from a C₁-C₄ alkyl group; and R of Formula I(B) is chosen from a C₁-C₁₈ alkyl group; C₆-C₁₂ aryl group; or a C₇-C₁₈ aralkyl group. In some embodiments, the compound according to Formulas I(A) or I(B) is selected from the group consisting of 2,5-dimercapto-1,3,4-thiadiazole; 2,5-dimercapto-1,3,4-thiadizaole dipotassium salt; 5-mercapto-3-phenyl-1,3,4-thiodiazole-2(3H)-thione potassium salt; and mixtures thereof.

In some embodiments, the heavy metal chelating agent having a plurality of sulfur groups is selected from the group consisting of: 2,3-dimercapto-1-propanol; 1,2-dithioethane; 1,3-dithiopropane; benzene-1,2-dithiol; 1,3-dimercapto-2-propanol; 1,2,3-tri-mercaptopropane; and mixtures thereof. In some embodiments, the heavy metal chelating agent is 2,3-dimercapto-1-propanol.

In some embodiments, the heavy metal chelating agent having a plurality of sulfur groups is a polymer according to

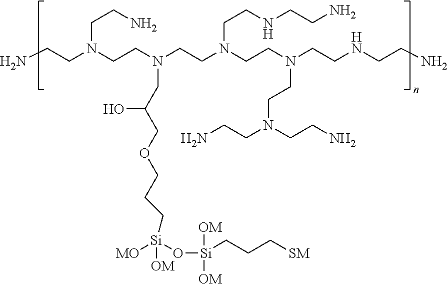

wherein each M is independently chosen from H, Na, K, Li, NH₄ and NR′₄, each R′ is independently chosen from a C₁-C₄ alkyl group, and n is the number of repeating units of the polymer backbone, and is an integer from 2 to 1000. In some embodiments, n is 2 to 100. In some embodiments, the polymer backbone comprises a backbone selected from the group consisting of: polyamine, polysaccharide, polyvinylpyrrolidone, polyglutamicacid, polyacrylamide, polydiacetone acrylamide, polyvinyl alcohol, polyethylene glycol, polyacrylic acid, chitosan, dextrin and mixtures of any of the foregoing; and co-polymers of any of the foregoing.

In certain embodiments, disclosed herein is a process for removing heavy metal ions from a phosphoric acid mixture, the process comprising adding to the phosphoric acid mixture an effective amount of a reagent comprising a heavy metal chelating agent comprising a plurality of sulfur groups as substituents wherein the reagent further comprises an effective amount of an organothiophosphorus compound. In some embodiments, the organothiophosphorus compound is selected from the group consisting of: organodithiophosphinic acid, organodithiophosphonic acid, organodithiophosphoric acid, organomonothiophosphinic acid, organomonothiophosphonic acid, organomonothiophosphoric acid, their corresponding salts in the form of sodium, ammonium, or potassium, and mixtures thereof. In some embodiments, the organothiophosphorus compound comprises organodithiophosphinic acid or corresponding salts thereof, or organodithiophosphoric acid or corresponding salts thereof. In some embodiments, the organodithiophosphinic acid is a dialkyldithiophosphinic acid, and the organodithiophosphoric acid is a dialkyldithiophosphoric acid.

In some embodiments of the process for removing heavy metal ions from a phosphoric acid mixture disclosed herein in any and all embodiments, the phosphoric acid mixture further comprises an adsorbent. In some embodiments, the adsorbent is calcium sulfate solid particles.

In some embodiments of the process for removing heavy metal ions from a phosphoric acid mixture disclosed herein, the process is performed at a temperature from 0 °C to 120 °C. In some embodiments, the process is performed at a temperature from about 10 °C to about 80 °C.

In some embodiments of the process for removing heavy metal ions from a phosphoric acid mixture disclosed herein, the phosphoric acid mixture has a concentration of P₂O₅ from 3 weight % to 70 weight %, based on the total weight of the mixture. In some embodiments, the phosphoric acid mixture has a concentration of P₂O₅ from 20 weight % to 60 weight %.

In some embodiments of the process for removing heavy metal ions from a phosphoric acid mixture disclosed herein, the reagent comprising a heavy metal chelating agent comprising a plurality of sulfur groups is added to the phosphoric acid mixture at a dosage from 0.1 kg/ton and 10 kg/ton of P₂O₅.

In some embodiments of the process for removing heavy metal ions from a phosphoric acid mixture disclosed herein, the process further comprises a step of separating the phosphoric acid mixture. In some embodiments, the separating step further comprises flocculation. In some embodiments of the process for removing heavy metal ions from a phosphoric acid mixture disclosed herein the separating step further comprises filtration.

In some embodiments of the process for removing heavy metal ions from a phosphoric acid mixture disclosed herein the separating step further comprises skimming.

Disclosed herein, in certain embodiments, is a reagent for removing heavy metal ions from a phosphoric acid mixture comprising (a) a heavy metal chelating agent comprising a plurality of sulfur groups and (b) an organothiophosphorus compound comprising an organodithiophosphinic acid or corresponding salts thereof, or organodithiophosphoric acid or corresponding salts thereof.

In some embodiments of the reagent for removing heavy metal ions from a phosphoric acid mixture, the heavy metal chelating agent having a plurality of sulfur groups is selected from the group consisting of (i) 2,5-dimercapto-1,3,4-thiadiazole; 2,5-dimercapto-1,3,4-thiadiazole dipotassium salt; and 5-mercapto-3-phenyl-1,3,4-thiodiazole-2(3H)-thione potassium salt; (ii) 2,3-dimercapto-1-propanol; 1,2-dithioethane; 1,3-dithiopropane; benzene-1,2-dithiol; 1,3-dimercapto-2-propanol; and 1,2,3-tri-mercaptopropane.

In some embodiments of the reagent for removing heavy metal ions from a phosphoric acid mixture, the heavy metal chelating agent having a plurality of sulfur groups is a polymer as defined by

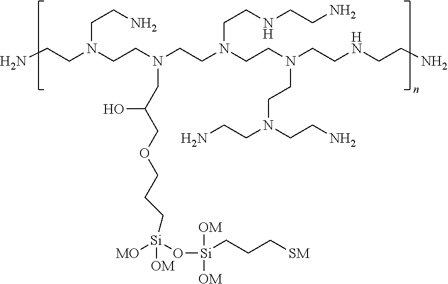

wherein each M is independently chosen from H, Na, K, Li, NH₄ and NR′₄, each R′ is independently chosen from a C₁-C₄ alkyl group, and n is the number of repeating units of the polymer backbone, and is an integer from 2 to 1000. In some embodiments, n is 2 to 100. In some embodiments, the polymer comprises a backbone selected from the group consisting of: polyamine, polysaccharide, polyvinylpyrrolidone, polyglutamicacid, polyacrylamide, polydiacetone acrylamide, polyvinyl alcohol, polyethylene glycol, polyacrylic acid, chitosan, dextrin and mixtures of any of the foregoing; and co-polymers of any of the foregoing.

In some embodiments, the reagent comprises mixtures of any of the foregoing heavy metal chelating agent comprising a plurality of sulfur groups as substituents. In some embodiments of the reagent removing heavy metal ions from a phosphoric acid mixture, the heavy metal chelating agent is 2,3-dimercapto-1-propanol.

Disclosed herein, in certain embodiments, is a reagent for removing heavy metal ions from a phosphoric acid mixture comprising
(a) a heavy metal chelating agent comprising a plurality of sulfur groups which comprises a member selected from the group consisting of:
(i) 2,5-dimercapto-1,3,4-thiadiazole; 2,5-dimercapto-1,3,4-thiadiazole dipotassium salt; and 5-mercapto-3-phenyl-1,3,4-thiodiazole-2(3H)-thione potassium salt;
(ii) 2,3-dimercapto-1-propanol; 1,2-dithioethane; 1,3-dithiopropane; benzene-1,2-dithiol; 1,3-dimercapto-2-propanol; and 1,2,3-tri-mercaptopropane;
(iii) a polymer as defined by the heavy metal chelating agent having a plurality of sulfur groups is a polymer as defined by

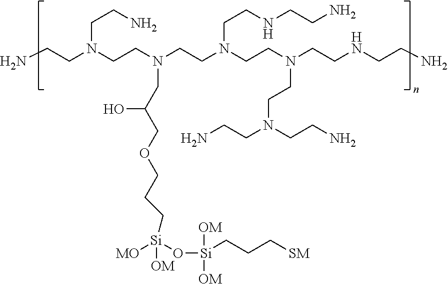

wherein each M is independently chosen from H, Na, K, Li, NH₄ and NR′₄, each R′ is independently chosen from a C₁-C₄ alkyl group, and n is the number of repeating units of the polymer backbone, and is an integer from 2 to 1000, and wherein in some embodiments, n is 2 to 100, and in some embodiments, the polymer comprises a backbone selected from the group consisting of: polyamine, polysaccharide, polyvinylpyrrolidone, polyglutamicacid, polyacrylamide, polydiacetone acrylamide, polyvinyl alcohol, polyethylene glycol, polyacrylic acid, chitosan, dextrin and mixtures of any of the foregoing; and co-polymers of any of the foregoing; and
(iv) mixtures of any of the foregoing, and
(b) an organothiophosphorus compound comprising an organodithiophosphinic acid or corresponding salts thereof, or organodithiophosphoric acid or corresponding salts thereof.

In some embodiments, the heavy metal chelating agent is 2,3-dimercapto-1-propanol.

The following examples are provided to assist one skilled in the art to further understand certain embodiments of the present invention. These examples are intended for illustration purposes and should not be construed as limiting the scope of the present invention.

The performances of certain heavy metal chelating agents comprising a plurality of sulfur groups for removing heavy metal ions from aqueous solutions containing phosphoric acid, including 2,5-Dimercapto-1,3,4-thiadiazole or its derivatives, 2,3-Dimercapto-1-propanol or its derivatives, or thio-containing polymer or its derivatives, and mixtures thereof to remove heavy metals are evaluated with phosphoric acid and phosphoric acid slurries.

The phosphoric acids with different P₂O₅ levels are obtained from plants. The phosphoric acid slurries are generated with a bench-scale digestion process. To separate the heavy metal precipitates from the acid, either a syringe filter or a vacuum filtration is used. Afterwards, the filtrate acids are analyzed with ICP (Inductively Coupled Plasma) to determine the level of various heavy metal elements. The general procedures for the test and experimental examples are outlined below.

DMTD-2K (2,5-Dimercapto-1,3,4-thiadiazole dipotassium salt), DMTD (2,5-Dimercapto-1,3,4-thiadiazole), Bismuthiol II (5-Mercapto-3-phenyl-1,3,4-thiodiazole-2(3H)-thione potassium salt), 2-Aminothiophenol, and Trimercapto-s-triazine trisodium salt are purchased from Sigma Aldrich. DTG (2,3-Dimercapto-1-propanol) is purchased from Sigma Aldrich. Na-DTPi (Sodium diisobutyl dithiophosphinate) and Na-DTP (Sodium diisobutyl dithiophosphate) are obtained from Solvay SA.

2-Aminothiophenol is dosed directly into acid without dilution. DTG is dosed into phosphoric acid/slurry as-is. Solutions of other reagents are prepared first before being dosed into phosphoric acid/slurry. For examples, a 10 wt % solution of DMTD-2K in water is prepared before dosed into acid. A 10 wt % solution of Bismuthiol II in water is prepared before dosed into acid. A 10 wt % solution of DMTD in basic sodium hydroxide solution is prepared before dosed into acid. A 10 wt % solution of Trimercapto-s-triazine trisodium salt in water is prepared before dosed into acid. A 5 wt % solution of sodium diisobutyl dithiophosphinate in water is prepared before dosed into acid. A 5 wt % solution of sodium diisobutyl dithiophosphate in water is prepared before dosed into acid. For Examples 1F-3, 1P-3, and 3D-4, a solution of 6% DMTD-2K and 2% Na-DTPi is prepared before dosed into acid. The dosages shown in the tables are calculated based on the amount of dry reagents relative to the amount of P₂O₅ in acid/slurry.

### Example 1—Process for Removing Heavy Metals from Plant Weak Phosphoric Acids (~30% P₂O₅) at Elevated Temperature (75 °C and 50 °C)

35 g of plant phosphoric acid from plant #1 and #2 (~30% P₂O₅, collected from the clarification tank after filtration) is transferred into a glass jar with a magnetic stir bar. The acid is heated to 80 °C in a water bath. An effective amount (as listed in Table 1) of a reagent of interest is dosed into acid under agitation at 600 rpm. For Examples 1L-3 and 1R-3, two reagents are dosed at the same time with two separate pipettes. After agitation for 1 minute and settlement for another minute, the acid is transferred into a syringe and filtered with a 0.2 μm polyvinylidene difluoride (PVDF) syringe filter. The filtrate is collected and then submitted for ICP elemental analysis. The results are shown in Table 1.

When two reagents of interest are dosed sequentially (as in Examples 1D-1, 1D-2, 1F-1, 1F-2, 1H, 1K-1 to 1K-5, 1L-1, 1L-2, 1P-1, 1P-2, 1R-1, and 1R-2), the 1st reagent is dosed into acid under agitation of 600 rpm and agitated for 1 minute, and then the 2nd reagent is dosed into acid under agitation of 600 rpm and agitated for 1 minute. Afterwards, the acid is settled for another minute and then transferred into a syringe and filtered with a 0.2 μm polyvinylidene difluoride (PVDF) syringe filter. The filtrate is collected and then submitted for ICP elemental analysis.

TABLE 1

| | Plant | | | | | | | |
|---|---|---|---|---|---|---|---|---|
| | phosphoric | | | Dosage | | | Percentage | Percentage |
| | acid | Temp. | | (kg/T | As | Cd | of As | of Cd |
| Example | (~30% P₂O₅) | (°C) | Reagents | P₂O₅) | (ppm) | (ppm) | removed | removed |
| 1A | #1 | ~75 | Blank #1 | — | 9.92 | 28.68 | — | — |
| 1B-1 | #1 | ~75 | DMTD-2K | 1.0 | 9.61 | 24.29 | 3.1% | 15.3% |
| 1B-2 | #1 | ~75 | DMTD-2K | 2.5 | 9.64 | 21.87 | 2.9% | 23.7% |
| 1B-3 | #1 | ~75 | DMTD-2K | 3.0 | 9.66 | 18.57 | 2.6% | 35.3% |
| 1B-4 | #1 | ~75 | DMTD-2K | 4.0 | 7.24 | 6.94 | 27.1% | 75.8% |
| 1B-5 | #1 | ~75 | DMTD-2K | 6.0 | 4.98 | 4.51 | 49.8% | 84.3% |
| 1B-6 | #1 | ~75 | DMTD-2K | 9.0 | 3.83 | 3.82 | 61.4% | 86.7% |
| 1C-1 | #1 | ~75 | Na-DTPi | 0.5 | 9.90 | 28.04 | 0.2% | 2.2% |
| 1C-2 | #1 | ~75 | Na-DTPi | 1.0 | 9.91 | 26.15 | 0.1% | 8.8% |
| 1D-1 | #1 | ~75 | DMTD-2K | 2.5 then 0.5 | 6.37 | 17.61 | 35.8% | 38.6% |
| | | | then Na-DTPi | | | | | |
| 1D-2 | #1 | ~75 | DMTD-2K | 6.0 then 0.5 | 1.24 | 3.01 | 87.5% | 89.5% |
| | | | then Na-DTPi | | | | | |
| 1E | #1 | ~75 | Sodium Na- | 1.0 | 9.80 | 25.33 | 1.2% | 11.7% |
| | | | DTP | | | | | |
| 1F-1 | #1 | ~75 | DMTD-2K | 3.0 then 1.0 | 3.43 | 16.78 | 65.4% | 41.5% |
| | | | then Na-DTP | | | | | |
| 1F-2 | #1 | ~75 | Na-DTP | 1.0 then 3.0 | 3.56 | 12.25 | 64.1% | 57.3% |
| | | | then DMTD- | | | | | |
| | | | 2K | | | | | |
| 1F-3 | #1 | ~75 | DMTD-2K | 3.0 & 1.0 | 4.56 | 16.86 | 54.1% | 41.2% |
| | | | and Na-DTP | | | | | |
| 1G-1 | #1 | ~75 | Bismuthiol II | 2.5 | 7.70 | 18.39 | 22.4% | 35.9% |
| 1G-2 | #1 | ~75 | Bismuthiol II | 4.0 | 5.84 | 7.36 | 41.2% | 74.3% |
| 1G-3 | #1 | ~75 | Bismuthiol II | 6.0 | 1.42 | 1.23 | 85.7% | 95.7% |
| 1H | #1 | ~75 | Bismuthiol II | 4.0 then 1.0 | 1.35 | 0.59 | 86.4% | 97.9% |
| | | | then Na-DTP | | | | | |
| 1I-1 | #1 | ~75 | DMTD | 2.5 | 8.31 | 7.79 | 16.2% | 72.8% |
| 1I-2 | #1 | ~75 | DMTD | 4.0 | 4.51 | 3.09 | 54.6% | 89.2% |
| 1I-3 | #1 | ~75 | DMTD | 6.0 | 1.67 | 1.72 | 83.2% | 94.0% |
| 1I-4 | #1 | ~75 | DMTD | 9.0 | 0.57 | 0.44 | 94.2% | 98.5% |
| 1J-1 | #1 | ~75 | DTG | 0.5 | 9.16 | 28.70 | 7.7% | −0.1% |
| 1J-2 | #1 | ~75 | DTG | 0.8 | 8.00 | 28.36 | 19.4% | 1.1% |
| 1J-3 | #1 | ~75 | DTG | 1.0 | 3.65 | 27.90 | 63.2% | 2.7% |
| 1J-4 | #1 | ~75 | DTG | 2.0 | 0.66 | 29.62 | 93.4% | −3.3% |
| 1J-5 | #1 | ~75 | DTG | 4.0 | 0.67 | 28.56 | 93.3% | 0.4% |
| 1K-1 | #1 | ~75 | DTG then Na- | 0.5 then 0.5 | 7.06 | 22.20 | 28.8% | 22.6% |
| | | | DTPi | | | | | |
| 1K-2 | #1 | ~75 | DTG then Na- | 0.8 then 1.0 | 5.32 | 0.59 | 46.4% | 97.9% |
| | | | DTPi | | | | | |
| 1K-3 | #1 | ~75 | DTG then Na- | 1.0 then 0.5 | 2.19 | 7.82 | 77.9% | 72.7% |
| | | | DTPi | | | | | |
| 1K-4 | #1 | ~75 | DTG then Na- | 2.0 then 0.5 | 0.60 | 3.61 | 93.9% | 87.4% |
| | | | DTPi | | | | | |
| 1K-5 | #1 | ~75 | DTG then Na- | 4.0 then 0.5 | 0.62 | 3.12 | 93.7% | 89.1% |
| | | | DTPi | | | | | |
| 1L-1 | #1 | ~75 | DTG then Na- | 1.0 then 1.0 | 1.86 | 2.63 | 81.2% | 90.8% |
| | | | DTP | | | | | |
| 1L-2 | #1 | ~75 | Na-DTP then | 1.0 then 1.0 | 0.61 | 22.71 | 93.8% | 20.8% |
| | | | DTG | | | | | |
| 1L-3 | #1 | ~75 | DTG and Na- | 1.0 & 1.0 | 0.87 | 20.99 | 91.2% | 26.8% |
| | | | DTP | | | | | |
| 1M | #1 | 50 | Blank #1 | — | 10.15 | 26.77 | — | — |
| IN | #1 | 50 | DMTD-2K | 3.0 | 2.54 | 1.68 | 75.0% | 93.7% |
| 1O | #1 | 50 | Na-DTPi | 1.0 | 9.21 | 24.20 | 9.2% | 9.6% |
| 1P-1 | #1 | 50 | DMTD-2K | 3.0 then 1.0 | 0.63 | 0.62 | 93.8% | 97.7% |
| | | | then Na-DTPi | | | | | |
| 1P-2 | #1 | 50 | Na-DTPi then | 1.0 then 3.0 | 0.69 | 0.39 | 93.2% | 98.5% |
| | | | DMTD-2K | | | | | |
| 1P-3 | #1 | 50 | DMTD-2K | 3.0 & 1.0 | 0.56 | 0.76 | 94.5% | 97.2% |
| | | | and Na-DTPi | | | | | |
| 1Q | #1 | 50 | DTG | 1.0 | 1.05 | 26.50 | 89.6% | 1.0% |
| 1R-1 | #1 | 50 | DTG then Na- | 1.0 then 1.0 | 0.92 | 0.30 | 91.0% | 98.9% |
| | | | DTPi | | | | | |
| 1R-2 | #1 | 50 | Na-DTPi then | 1.0 then 1.0 | 0.75 | 21.35 | 92.6% | 20.2% |
| | | | DTG | | | | | |
| 1R-3 | #1 | 50 | DTG and Na- | 1.0 & 1.0 | 0.76 | 13.86 | 92.5% | 48.2% |
| | | | DTPi | | | | | |
| 1S | #2 | ~75 | Blank #2 | — | 10.91 | 2.41 | — | — |
| 1T-1 | #2 | ~75 | DTG | 0.25 | 6.34 | 2.33 | 41.9% | 3.5% |
| 1T-2 | #2 | ~75 | DTG | 0.5 | 2.05 | 2.34 | 81.2% | 3.2% |
| 1T-3 | #2 | ~75 | DTG | 1.0 | 0.81 | 2.31 | 92.6% | 4.3% |
| Compar- | #1 | ~75 | 2- | 9.0 | — | 27.03 | — | −1.0% |
| ative 1 | | | Aminothiophenol | | | | | |
| Compar- | #1 | ~75 | Trimercapto-s- | 9.0 | — | 27.93 | — | −4.3% |
| ative 2 | | | triazine | | | | | |
| | | | trisodium salt | | | | | |

Results from Table 1 show the performance of various reagents for heavy metal removal from various plant phosphoric acids at variant temperatures. For example, DMTD-2K compound, when dosed at 3 kg/t P₂O₅ to the plant phosphoric acid #2 (30% P₂O₅) at 50 °C, was able to remove arsenic and cadmium by up to 75.0% and 93.7% respectively (Example 1N). Similarly, DMTD and Bismuthiol II were also able to remove a significant amount of arsenic and cadmium from the plant phosphoric acid. With DTG compound, more than 90% reduction in arsenic was observed at dosages of 2 kg/t P₂O₅ (Example 1J-4). More than 90% reduction in arsenic and cadmium was also observed when the plant phosphoric acid was treated with DMTD-2K and Na-DTPi in various dosing sequences (Examples 1P-1, 1P-2, 1P-3). Similar results were observed when plant phosphoric acid was treated with DTG and Na-DTPi (Examples 1R-1, 1R-2, 1R-3).

### Example 2—Process for Removing Heavy Metals from Digestion Phosphoric Acid Slurries (~30% P₂O₅) at ~80 °C). Calcium Sulfate Solid Particles in the Slurry Act as Adsorbents

Phosphoric acid slurries are generated via bench-scale digestion of phosphate ore by using a 500 ml jacketed reactor connected with a thermal bath for keeping temperature at around 80 °C. The reactor is also connected to a cooling condenser to avoid water evaporation during the digestion. Phosphoric acid and sulfuric acid are added continuously to the reactor through two peristaltic pumps (MasterFlex L/S). Phosphate rock/ore powder is manually added roughly continuously at a corresponding rate. The feed rate of sulfuric acid (52.4%) is 3.67 g/minute; feed rate of phosphoric acid (37.1%) is 7.67 g/minute; and phosphate ore powder is 2 g/minutes. The feeding time is around 30 minutes. After feeding acids and ores, the digestion is continued for an additional 2 to 3 hours to fully digest the phosphate ores. When reagents of interest and other additives (such as defoamer reagents) are used, effective amounts of reagents are first mixed with the aforementioned phosphoric acid and then continuously pumped into the reactor. During the whole process, the digestion slurry is stirred with an overhead stirrer (Glas-Col Precision Speed Controlled Stirrer) and a propeller-type impeller set at 300 rpm.

50 g of phosphoric acid slurry (~30% solid level, ~30% P₂O₅) post-digestion is transferred into a glass jar with a magnetic stir bar. The slurries contain a large amount (~30 wt. %) of solid particles, with the majority being calcium sulfate generated during the digestion of phosphate ore. An effective amount (as listed in Table 2) of a reagent of interest for heavy metal ions removal is dosed into the slurry under agitation at 600 rpm. After agitation for 1 minute, the slurry is transferred to a vacuum filtration funnel (on a filtration setup with a 45 μm polypropylene net filter (Millipore PP4504700)) and the vacuum filtration starts in ~15 seconds. The filtrate is collected and then submitted for ICP elemental analysis. The results are shown in Table 2 and plotted in FIG. 3.

When two reagents of interest are added sequentially (as in Examples 2D-1 and 2D-2), the 1st reagent is dosed into slurry under agitation of 600 rpm and agitated for 1 minute, and then the 2nd reagent is dosed into acid under agitation of 600 rpm and agitated for 1 minute. Afterwards, the slurry is transferred to a vacuum filtration funnel (on a filtration setup with a 45 μm polypropylene net filter (Millipore PP4504700)) and the vacuum filtration starts in ~15 seconds. The filtrate is collected and then submitted for ICP elemental analysis.

TABLE 2

| | | | | | Percentage | Percentage |
|---|---|---|---|---|---|---|
| | | Dosage | As | Cd | of As | of Cd |
| Example | Reagents | (kg/T P₂O₅) | (ppm) | (ppm) | removed | removed |
| 2A | Blank | — | 10.98 | 21.87 | — | — |
| 2B-1 | DMTD-2K | 1.0 | 10.55 | 20.28 | 3.9% | 7.3% |
| 2B-2 | DMTD-2K | 2.5 | 9.27 | 18.13 | 15.6% | 17.1% |
| 2B-3 | DMTD-2K | 4.0 | 1.09 | 10.76 | 90.1% | 50.8% |
| 2B-4 | DMTD-2K | 9.0 | 0.14 | 1.44 | 98.7% | 93.4% |
| 2C | Na-DTPi | 0.5 | 10.90 | 21.31 | 0.8% | 2.5% |
| 2D-1 | DMTD-2K | 2.5 then 0.5 | 3.62 | 16.32 | 67.0% | 25.4% |
| | then Na-DTPi | | | | | |
| 2D-2 | DMTD-2K | 4.0 then 0.5 | 0.32 | 10.07 | 97.1% | 53.9% |
| | then Na-DTPi | | | | | |

Results from Table 2 show that DMTD-2K, by itself or with Na-DTPi, effectively removes arsenic and cadmium from the plant phosphoric acid (30% P₂O₅). The performance improves with increase in the dosage of DMTD-2K.

### Example 3—Process for Removing Heavy Metals from Concentrated Phosphoric Acids (~50% P₂O₅) at Elevated Temperature (70 °C) or Room Temperature (20 °C)

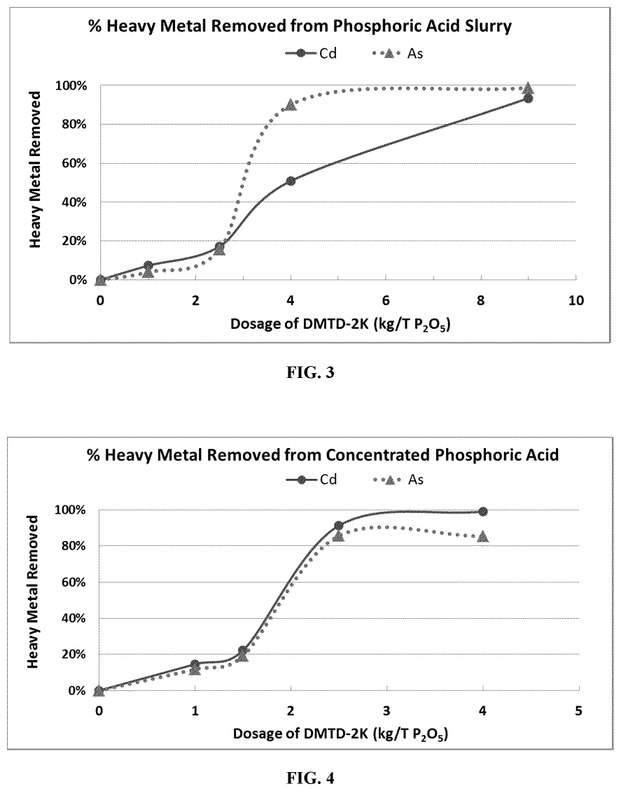

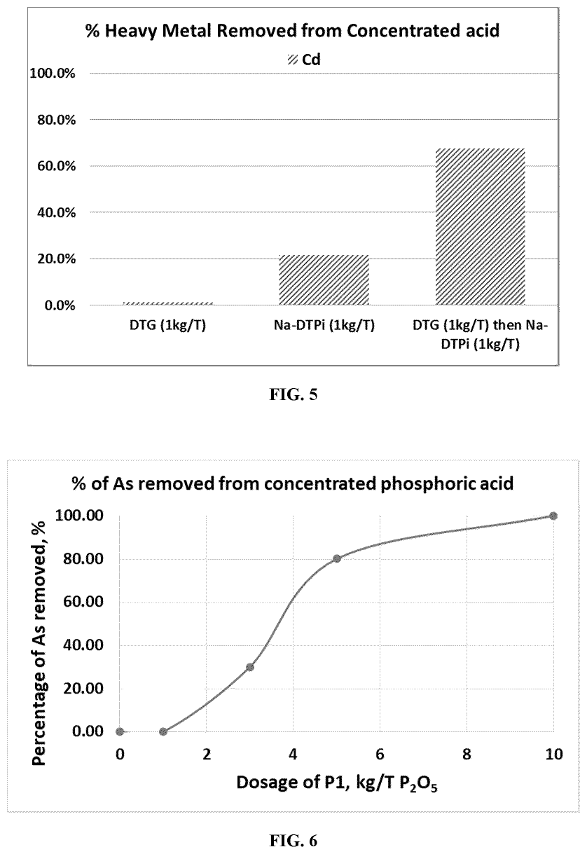

50 g of plant phosphoric acid (~50% P₂O₅, concentrated from plant acid with 30% P₂O₅) is transferred into a glass jar with a magnetic stir bar. An effective amount (as listed in Table 3) of a reagent of interest for removing heavy metal ions is dosed into acid under agitation at 600 rpm. For Example 3F-4, two reagents are dosed at the same time with two separate pipettes. After agitation for 2 minutes and settlement for another 2 minutes, the acid is transferred into a syringe and filtered with a 0.2 μm polyvinylidene difluoride (PVDF) syringe filter. The filtrate is collected and then submitted for ICP elemental analysis. The results are shown in Table 3 and plotted in FIG. 4.

When two reagents of interest are dosed sequentially (as in Examples 3D-1, 3D-2, 3D-3, 3F-1, 3F-2, 3F-3, 3J, and 3L), the 1st reagent is dosed into acid under agitation of 600 rpm and agitated for 1 minute, and then the 2nd reagent is dosed into acid under agitation of 600 rpm and agitated for 1 minute. Afterwards, the acid is settled for another 2 minutes and then transferred into a syringe and filtered with a 0.2 μm polyvinylidene difluoride (PVDF) syringe filter. The filtrate is collected and then submitted for ICP elemental analysis.

TABLE 3

| | Concentrated | | | | | | | |
|---|---|---|---|---|---|---|---|---|
| | Plant | | | Dosage | | | Percentage | Percentage |
| | phosphoric | Temp. | | (kg/T | As | Cd | of As | of Cd |
| Example | acid | (°C) | Reagents | P₂O₅) | (ppm) | (ppm) | removed | removed |
| 3A | 50% P₂O₅ | 70 | Blank | — | 7.07 | 62.71 | — | — |
| 3B-1 | 50% P₂O₅ | 70 | DMTD-2K | 1.0 | 6.24 | 53.55 | 11.8% | 14.6% |
| 3B-2 | 50% P₂O₅ | 70 | DMTD-2K | 1.5 | 5.71 | 48.77 | 19.2% | 22.2% |
| 3B-3 | 50% P₂O₅ | 70 | DMTD-2K | 2.5 | 1.02 | 5.47 | 85.6% | 91.3% |
| 3B-4 | 50% P₂O₅ | 70 | DMTD-2K | 4.0 | 1.04 | 0.62 | 85.3% | 99.0% |
| 3C-1 | 50% P₂O₅ | 70 | Na-DTPi | 0.5 | 6.96 | 58.58 | 1.6% | 6.6% |
| 3C-2 | 50% P₂O₅ | 70 | Na-DTPi | 1.0 | 5.35 | 49.22 | 24.3% | 21.5% |
| 3D-1 | 50% P₂O₅ | 70 | DMTD-2K | 1.0 | 1.16 | 15.31 | 83.6% | 75.6% |
| | | | then | then | | | | |
| | | | Na-DTPi | 1.0 | | | | |
| 3D-2 | 50% P₂O₅ | 70 | DMTD-2K | 1.5 | 1.17 | 15.70 | 83.5% | 75.0% |
| | | | then | then | | | | |
| | | | Na-DTPi | 0.5 | | | | |
| 3D-3 | 50% P₂O₅ | 70 | Na-DTPi | 0.5 | 1.27 | 16.69 | 82.0% | 73.4% |
| | | | then | then | | | | |
| | | | DMTD-2K | 1.5 | | | | |
| 3D-4 | 50% P₂O₅ | 70 | DMTD-2K | 1.5 & | 1.34 | 18.30 | 81.1% | 70.8% |
| | | | and | 0.5 | | | | |
| | | | Na-DTPi | | | | | |
| 3E-1 | 50% P₂O₅ | 70 | DTG | 1.0 | 4.08 | 62.00 | 42.2% | 1.1% |
| 3E-2 | 50% P₂O₅ | 70 | DTG | 2.0 | 1.65 | 57.76 | 76.7% | 7.9% |
| 3E-3 | 50% P₂O₅ | 70 | DTG | 2.5 | 1.17 | 57.79 | 83.4% | 7.9% |
| 3F-1 | 50% P₂O₅ | 70 | DTG then | 1.0 | 1.85 | 20.33 | 73.9% | 67.6% |
| | | | Na-DTPi | then | | | | |
| | | | | 1.0 | | | | |
| 3F-2 | 50% P₂O₅ | 70 | DTG then | 2.5 | 1.34 | 33.48 | 81.0% | 46.6% |
| | | | Na-DTPi | then | | | | |
| | | | | 0.5 | | | | |
| 3F-3 | 50% P₂O₅ | 70 | Na-DTPi | 0.5 | 1.29 | 36.42 | 81.8% | 41.9% |
| | | | then DTG | then | | | | |
| | | | | 2.5 | | | | |
| 3F-4 | 50% P₂O₅ | 70 | DTG and | 2.5 & | 1.32 | 34.78 | 81.3% | 44.5% |
| | | | Na-DTPi | 0.5 | | | | |
| 3G | 52% P₂O₅ | 20 | Blank | — | 7.21 | 63.62 | — | — |
| 3H | 52% P₂O₅ | 20 | DMTD-2K | 3.0 | 1.40 | 39.05 | 82.2% | 38.6% |
| 3I | 52% P₂O₅ | 20 | Na-DTPi | 0.5 | 7.17 | 57.16 | 0.6% | 10.2% |
| 3J | 52% P₂O₅ | 20 | DMTD-2K | 3.0 | 1.44 | 19.66 | 81.6% | 69.1% |
| | | | then | then | | | | |
| | | | Na-DTPi | 0.5 | | | | |
| 3K | 52% P₂O₅ | 20 | DTG | 3.0 | 2.01 | 64.79 | 72.2% | −1.8% |
| 3L | 52% P₂O₅ | 20 | DTG then | 3.0 | 2.30 | 19.80 | 68.2% | 68.9% |
| | | | Na-DTPi | then | | | | |
| | | | | 0.5 | | | | |

Results shown in Table 3 indicate significant reduction (over 80%) in the arsenic and cadmium from concentrated plant phosphoric acid (50% P₂O₅) when treated with DMTD-2K (Examples 3B-3 and 3B-4). Similar performance for As removal was observed when the concentrated plant phosphoric acid was treated with DTG (Example 3E-3). In both cases, the performance improved when the dosage of these compounds was increased. Great performance were also observed when DMTD-2K or DTG is co-dosed with Na-DTPi at various sequences.

### Example 4—Process for Removing Arsenic from Concentrated Phosphoric Acids (~46% P₂O₅) at Elevated Temperature (70 °C) Using Thiol-Containing Polymers

Synthesis of thiol-containing polymer P1. Polyethylenimine (Epomin SP-018, 5 g, 0.0028 mol) and C8-C10 alkyl glycidyl ether (GE-7, 2.64 g, 0.0117 mol) are added to a flask, and stirred at 80 °C for 1 h. Deionized water (95.54 g) and 10% NaOH solution (9.33 g) are added to the flask to form a clear solution, followed by the addition of (3-glycidyloxypropyl)trimethoxysilane (GPTS, 2.76 g, 0.0117 mol). After stirring for 30 min, (3-mercaptopropyl)trimethoxysilane (MPTS, 2.29 g, 0.0117 mol) dissolved in 10% NaOH aqueous solution (9.33 g) is added to the flask slowly. The mixture is stirred at 40 °C for 2 h, yielding a solution of thiol-containing polymer with 10 wt % polymer concentration. The weight percentage of MPTS in polymer i 18.05%.

Synthesis of thiol-containing polymer P2. Polyethylenimine (Epomin SP-018, 0.87 g, 0.0005 mol) and C₈-C₁₀ alkyl glycidyl ether (GE-7, 0.46 g, 0.0020 mol) are added to a flask, and stirred at 80 °C for 1 h. Deionized water (6.58 g) and 10% NaOH solution (1.62 g) are added to the flask to form a clear solution, followed by the addition of (3-glycidyloxypropyl)trimethoxysilane (GPTS, 0.48 g, 0.0020 mol). After stirring at 40 °C for 30 min, a solution of (3-mercaptopropyl)trimethoxysilane (MPTS, 1.19 g, 0.0061 mol), 50% NaOH aqueous solution (0.97 g) and deionized water (7.77 g) is added to the flask slowly. The mixture is stirred at 40 °C for 2 h, yielding a solution of thiol-containing polymer with 15.00% polymer concentration. The weight percentage of MPTS in polymer is 39.79%.

Synthesis of thiol-containing polymer P3. Polyethylenimine (Epomin SP-018, 0.35 g, 0.0002 mol) and C₈-C₁₀ alkyl glycidyl ether (GE-7, 0.18 g, 0.0008 mol) are added to a flask, and stirred at 80 °C for 1 h. Deionized water (2.63 g) and 10% NaOH solution (0.65 g) are added to the flask to form a clear solution, followed by the addition of (3-glycidyloxypropyl)trimethoxysilane (GPTS, 0.19 g, 0.0008 mol). After stirring at 40 °C for 30 min, a solution of (3-mercaptopropyl)trimethoxysilane (MPTS, 1.59 g, 0.0081 mol), 50% NaOH aqueous solution (1.29 g) and deionized water (8.52 g) is added to the flask slowly. The mixture is stirred at 40 °C for 2 h, yielding a solution of thiol-containing polymer with 14.98% polymer concentration. The weight percentage of MPTS in polymer is 68.78%.

Synthesis of thiol-containing polymer P4. Polyethylenimine (Epomin SP-018, 0.68 g, 0.0004 mol) and C₈-C₁₀ alkyl glycidyl ether (GE-7, 0.36 g, 0.0016 mol) are added to a flask, and stirred at 80 °C for 1 h. Deionized water (7.69 g) and 10% NaOH solution (0.51 g) are added to the flask to form a clear solution, followed by the addition of (3-glycidyloxypropyl)trimethoxysilane (GPTS, 0.75 g, 0.0032 mol). After stirring at 40 °C for 30 min, a solution of (3-mercaptopropyl)trimethoxysilane (MPTS, 0.63 g, 0.0032 mol), 50% NaOH aqueous solution (0.51 g) and deionized water (5.04 g) is added to the flask slowly. The mixture is stirred at 40 °C for 2 h, yielding a solution of thiol-containing polymer with 15.00% polymer concentration. The weight percentage of MPTS in polymer is 25.83%.

Synthesis of thiol-containing polymer P5. Polyethylenimine (Epomin SP-018, 0.86 g, 0.0005 mol) is dissolved in deionized water (7.69 g) and 10% NaOH solution (0.64 g) in a flask at 40 °C (3-glycidyloxypropyl)trimethoxysilane (GPTS, 0.94 g, 0.0040 mol) is added to the flask slowly. After stirring at 40 °C for 30 min, a solution of (3-mercaptopropyl)trimethoxysilane (MPTS, 0.78 g, 0.0004 mol), 50% NaOH aqueous solution (0.64 g) and deionized water (5.81 g) is added to the flask slowly. The mixture is stirred at 40 °C for 2 h, yielding a solution of thiol-containing polymer with 15.00% wt % polymer concentration. The weight percentage of MPTS in polymer is 30.35%.

Synthesis of thiol-containing polymer P6. Tetraethylenepentamine (0.58 g, 0.0031 mol) and C₈-C₁₀ alkyl glycidyl ether (GE-7, 0.69 g, 0.0031 mol) are added to a flask, and stirred at 80 °C for 1 h. Deionized water (7.51 g) and 50% NaOH solution (0.49 g) are added to the flask to form a clear solution, followed by the addition of (3-glycidyloxypropyl)trimethoxysilane (GPTS, 0.72 g, 0.0031 mol). After stirring at 40 °C for 30 min, a solution of (3-mercaptopropyl)trimethoxysilane (MPTS, 0.60 g, 0.0031 mol), 50% NaOH aqueous solution (0.25 g) and deionized water (6.50 g) is added to the flask slowly. The mixture is stirred at 40 °C for 2 h, yielding a solution of thiol-containing polymer with 15.00% polymer concentration. The weight percentage of MPTS in polymer is 23.14%.

TABLE 4
Characteristics of the thiol-containing polymers.

| | | | Weight |
|---|---|---|---|
| MPTS- | | Polyamine:GE- | percentage |
| containing | | 7:GPTS:MPTS | of MPTS in |
| polymers | Polyamine | (molar ratio) | polymer |
| P1 | Epomin SP-018 | 0.23:1:1:1 | 18.05% |
| P2 | Epomin SP-018 | 0.24:1:1:3 | 39.79% |
| P3 | Epomin SP-018 | 0.24:1:10 | 68.80% |
| P4 | Epomin SP-018 | 0.24:1:2:1 | 25.80% |
| P5 | Epomin SP-018 | 0.12:0:2:1 | 30.30% |
| P6 | Tetraethylenepentamine | 1:1:1:1 | 23.14% |

To conduct a heavy metal removal test, 25 g of plant phosphoric acid (~46% P₂O₅) is transferred into a glass vial with a magnetic stir bar. An effective amount of a reagent of interest for removing heavy metal ions (listed in Table 4, and also neat MPTS) is dosed into acid under agitation at 600 rpm. After agitation for 30 minutes, the acid is transferred into a syringe and filtered with a 0.45 m polyvinylidene difluoride (PVDF) syringe filter. The filtrate is collected and then submitted for ICP elemental analysis. The results are shown in Table 5.

TABLE 5

| | Concentrated | | | Dosage | | | |
|---|---|---|---|---|---|---|---|
| | Plant | | | Polymer, | MPTS, | | Percentage |
| | phosphoric | Temp. | | kg/T | kg/T | As | of As |
| Example | acid | (°C) | Reagents | P₂O₅ | P₂O₅ | (ppm) | removed |
| 4A | 46% P₂O₅ | 70 | Blank | — | | 40 | — |
| 4B-1 | 46% P₂O₅ | 70 | P1 | 1.00 | 0.18 | 40 | 0.00% |
| 4B-2 | 46% P₂O₅ | 70 | P1 | 3.00 | 0.54 | 28 | 30.00% |
| 4B-3 | 46% P₂O₅ | 70 | P1 | 5.00 | 0.90 | 8 | 80.00% |
| 4B-4 | 46% P₂O₅ | 70 | P1 | 10.00 | 1.80 | ND | 100.00% |
| 4C | 46% P₂O₅ | 70 | Blank | — | | 37 | — |
| 4D-1 | 46% P₂O₅ | 70 | P2 | 0.78 | 0.31 | 37 | 0.00% |
| 4D-2 | 46% P₂O₅ | 70 | P2 | 1.30 | 0.52 | 36 | 2.70% |
| 4D-3 | 46% P₂O₅ | 70 | P2 | 2.09 | 0.83 | 28 | 24.32% |
| 4D-4 | 46% P₂O₅ | 70 | P2 | 3.24 | 1.29 | 12 | 67.57% |
| 4D-5 | 46% P₂O₅ | 70 | P2 | 4.97 | 1.98 | 2 | 94.59% |
| 4E-1 | 46% P₂O₅ | 70 | P3 | 0.67 | 0.46 | 37 | 0.00% |
| 4E-2 | 46% P₂O₅ | 70 | P3 | 1.00 | 0.69 | 35 | 5.41% |
| 4E-3 | 46% P₂O₅ | 70 | P3 | 1.97 | 1.36 | 16 | 56.76% |
| 4E-4 | 46% P₂O₅ | 70 | P3 | 3.22 | 2.22 | 4 | 89.19% |
| 4E-5 | 46% P₂O₅ | 70 | P3 | 5.08 | 3.49 | 3 | 91.89% |
| 4F | 46% P₂O₅ | 70 | Blank | — | | 40 | — |
| 4G-1 | 46% P₂O₅ | 70 | P4 | 1.00 | 0.26 | 40 | 0.00% |
| 4G-2 | 46% P₂O₅ | 70 | P4 | 2.00 | 0.52 | 37 | 7.50% |
| 4G-3 | 46% P₂O₅ | 70 | P4 | 4.00 | 1.03 | 24 | 40.00% |
| 4G-4 | 46% P₂O₅ | 70 | P4 | 6.00 | 1.55 | 4 | 90.00% |
| 4G-5 | 46% P₂O₅ | 70 | P4 | 8.00 | 2.06 | ND | 100.00% |
| 4H-1 | 46% P₂O₅ | 70 | P5 | 1.00 | 0.30 | 40 | 0.00% |
| 4H-2 | 46% P₂O₅ | 70 | P5 | 2.00 | 0.61 | 39 | 2.50% |
| 4H-3 | 46% P₂O₅ | 70 | P5 | 4.45 | 1.35 | 16 | 60.00% |
| 4H-4 | 46% P₂O₅ | 70 | P5 | 5.89 | 1.78 | ND | 100.00% |
| 4H-5 | 46% P₂O₅ | 70 | P5 | 8.33 | 2.52 | ND | 100.00% |
| 4I | 46% P₂O₅ | 70 | Blank | — | | 39 | — |
| 4J-1 | 46% P₂O₅ | 70 | P6 | 1.00 | 0.23 | 37 | 0.00% |
| 4J-2 | 46% P₂O₅ | 70 | P6 | 2.00 | 0.46 | 34 | 8.11% |
| 4J-3 | 46% P₂O₅ | 70 | P6 | 4.00 | 0.93 | 18 | 51.35% |
| 4K | 46% P₂O₅ | 70 | Blank | — | | 37.00 | 0.00% |
| 4L-1 | 46% P₂O₅ | 70 | Neat | N/A | 0.50 | 33.00 | 10.81% |
| | | | MPTS | | | | |
| 4L-2 | 46% P₂O₅ | 70 | Neat | N/A | 1.00 | 25.00 | 32.43% |
| | | | MPTS | | | | |
| 4L-3 | 46% P₂O₅ | 70 | Neat | N/A | 2.00 | 19.00 | 48.65% |
| | | | MPTS | | | | |
| 4L-4 | 46% P₂O₅ | 70 | Neat | N/A | 3.00 | ND | 100.00% |
| | | | MPTS | | | | |

The results in Table 5 show that the thiol-containing polymers and neat MPTS can effectively remove the arsenic content in the plant phosphoric acid (~46% P₂O₅). The performance is improved with the increase in polymer dosage. Over 90% of arsenic reduction is achieved at a polymer dosage less than 10 kg/T P₂O₅. Compared with neat MPTS, thiol-containing polymers (except P3 and P6) show higher arsenic reduction at the same MPTS dosage.

### Example 5—Process for Removing Heavy Metals from Plant Phosphoric Acids (~30% P₂O₅) at Elevated Temperature (75 °C)

35 g of plant phosphoric acid from plant #3 (~30% P₂O₅, collected from the clarification tank after filtration) is transferred into a glass jar with a magnetic stir bar. The acid is heated to 80 °C in a water bath. An effective amount (as listed in Table 6) of a reagent of interest is dosed into acid under agitation at 600 rpm. After agitation for 1 minute and settlement for another minute, the acid is transferred into a syringe and filtered with a 0.2 μm polyvinylidene difluoride (PVDF) syringe filter. The filtrate is collected and then submitted for ICP elemental analysis. The results are shown in Table 6.

TABLE 6

| | Plant | | | | | | | |
|---|---|---|---|---|---|---|---|---|
| | phosphoric | | | Dosage | | | Percentage | Percentage |
| | acid | Temp. | | (kg/T | As | Cd | of As | of Cd |
| Example | (~30% P₂O₅) | (°C) | Reagents | P₂O₅) | (ppm) | (ppm) | removed | removed |
| 5A | #3 | ~75 | Blank #1 | — | 10.5 | 25.5 | — | — |
| 5B-1 | #3 | ~75 | DTG | 1.0 | 6.5 | 25.9 | 38.2% | −1.7% |
| 5B-2 | #3 | ~75 | DTG | 2.0 | 0.6 | 25.6 | 94.0% | −0.4% |
| 5B-3 | #3 | ~75 | DTG | 3.0 | 0.7 | 25.4 | 93.4% | 0.1% |
| 5C-1 | #3 | ~75 | 1,3-Dimercapto- | 1.0 | 10.4 | 25.2 | 0.7% | 1.0% |
| | | | 2-propanol | | | | | |
| 5C-2 | #3 | ~75 | 1,3-Dimercapto- | 2.0 | 9.4 | 25.0 | 10.5% | 2.0% |
| | | | 2-propanol | | | | | |
| 5C-3 | #3 | ~75 | 1,3-Dimercapto- | 3.0 | 2.5 | 26.1 | 75.7% | −2.3% |
| | | | 2-propanol | | | | | |
| 5D-1 | #1 | ~75 | 1,2,3-Tri- | 1.0 | 9.0 | 25.7 | 13.9% | −0.8% |
| | | | mercaptopropane | | | | | |
| 5D-2 | #1 | ~75 | 1,2,3-Tri- | 2.0 | 6.8 | 26.2 | 35.3% | −3.0% |
| | | | mercaptopropane | | | | | |
| 5D-3 | #1 | ~75 | 1,2,3-Tri- | 3.0 | 2.8 | 23.4 | 73.5% | 8.0% |
| | | | mercaptopropane | | | | | |
| 5E-1 | #1 | ~75 | 1,2-dithioethane | 1.0 | 9.8 | 25.9 | 6.0% | −1.6% |
| 5E-2 | #1 | ~75 | 1,2-dithioethane | 2.0 | 8.6 | 25.7 | 17.6% | −0.9% |
| 5E-3 | #1 | ~75 | 1,2-dithioethane | 3.0 | 0.8 | 25.3 | 92.8% | 0.8% |
| 5F-1 | #1 | ~75 | 1,3- | 1.0 | 10.6 | 25.8 | −1.0% | −1.4% |
| | | | dithiopropane | | | | | |
| 5F-2 | #1 | ~75 | 1,3- | 2.0 | 10.1 | 25.9 | 3.7% | −1.5% |
| | | | dithiopropane | | | | | |
| 5F-3 | #1 | ~75 | 1,3- | 3.0 | 8.7 | 25.6 | 16.4% | −0.3% |
| | | | dithiopropane | | | | | |
| 5G-1 | #1 | ~75 | benzene-1,2- | 1.0 | 10.4 | 26.8 | 0.8% | −5.1% |
| | | | dithiol | | | | | |
| 5G-2 | #1 | ~75 | benzene-1,2- | 2.0 | 9.2 | 25.1 | 12.2% | 1.5% |
| | | | dithiol | | | | | |
| 5G-3 | #1 | ~75 | benzene-1,2- | 3.0 | 9.0 | 25.2 | 13.6% | 1.1% |
| | | | dithiol | | | | | |
| 5H-1 | #1 | ~75 | 3-mercapto-1,2- | 1.0 | 10.0 | 25.3 | 4.7% | 0.5% |
| | | | propanediol | | | | | |
| 5H-2 | #1 | ~75 | 3-mercapto-1,2- | 2.0 | 10.0 | 25.5 | 4.0% | −0.2% |
| | | | propanediol | | | | | |
| 5H-3 | #1 | ~75 | 3-mercapto-1,2- | 3.0 | 10.0 | 25.1 | 4.6% | 1.6% |
| | | | propanediol | | | | | |
| 5I | #1 | ~75 | propylene glycol | 3.0 | 10.5 | 25.1 | −0.5% | 1.3% |

Results from Table 6 indicate that DTG, 1,3-Dimercapto-2-propanol, 1,2,3-Tri-mercaptopropane, 1,2-dithioethane, 1,3-dithiopropane, and benzene-1,2-dithiol; successfully remove arsenic from the plant phosphoric acid (30% P₂O₅). Among them, DTG, 1,3-Dimercapto-2-propanol, 1,2,3-Tri-mercaptopropane, and 1,2-dithioethane successfully remove significant amounts of arsenic from the plant phosphoric acid (30% P₂O₅).

Various patent and/or scientific literature references have been referred to throughout this application. The disclosures of these publications in their entireties are hereby incorporated by reference as if written herein. In view of the above description and the examples, one of ordinary skill in the art will be able to practice the invention as claimed without undue experimentation.

Although the foregoing description has shown, described, and pointed out the fundamental novel features of certain embodiments of the present invention, it will be understood that various omissions, substitutions, and changes in the form of the detail of the invention as described may be made by those skilled in the art, without departing from the scope of the present teachings. Consequently, the scope of the present invention should not be limited to the foregoing description or discussion, but should be defined by the appended claims.

1. A process for removing heavy metal ions from a phosphoric acid mixture, the process comprising:
adding to the phosphoric acid mixture an effective amount of a reagent comprising a heavy metal chelating agent having a plurality of sulfur groups,
wherein the heavy metal chelating agent having a plurality of sulfur groups is selected from:
a) a compound according to Formulas I(A) or I(B): 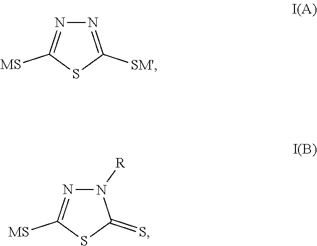
and salts thereof,
wherein
each M and M′ of Formula I(A) or I(B) is independently chosen from H, Na, K, Li, NH₄, NR′₄, wherein each R′ is independently chosen from a C₁-C₄ alkyl group; and
R of Formula I(B) is chosen from a C₁-C₁₈ alkyl group; C₆-C₁₂ aryl group; or a C₇-C₁₈ aralkyl group,
b) the group consisting of: 2,3-dimercapto-1-propanol; 1,2-dithioethane; 1,3-dithiopropane; benzene-1,2-dithiol; 1,3-dimercapto-2-propanol; 1,2,3-tri-mercaptopropane; and mixtures thereof,
c) a polymer according to: 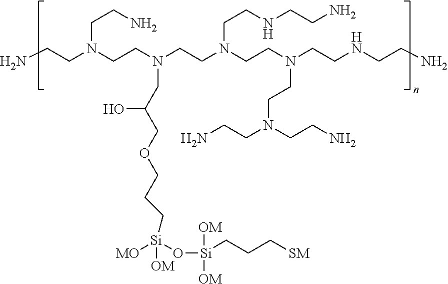
wherein each M is independently chosen from H, Na, K, Li, NH₄ and NR′₄, each R′ is independently chosen from a C₁-C₄ alkyl group, and n is the number of repeating units of the polymer backbone, and is an integer from 2 to 1000, or
d) mixtures of any of the foregoing.

2. The process according to claim 1, wherein the phosphoric acid mixture is a solution.

3. The process according to claim 1, wherein the phosphoric acid mixture is a slurry.

4. The process according to claim 1, wherein the heavy metal ion is selected from the group consisting of cadmium, copper, arsenic, mercury, lead, and mixtures of any of the foregoing.

5. The process according to claim 4, wherein the heavy metal ion is cadmium.

6. The process according to claim 4, wherein the heavy metal ion is arsenic.

7. (canceled)

8. The process according to claim 1, wherein the compound according to Formulas I(A) or I(B) is selected from the group consisting of 2,5-dimercapto-1,3,4-thiadiazole; 2,5-dimercapto-1,3,4-thiadiazole dipotassium salt; 5-mercapto-3-phenyl-1,3,4-thiodiazole-2(3H)-thione potassium salt; and mixtures thereof.

9. (canceled)

10. The process according to claim 1, wherein the heavy metal chelating agent is 2,3-dimercapto-1-propanol.

11. (canceled)

12. The process according to claim 1, wherein n is 2 to 100.

13. The process according to claim 1, wherein the polymer comprises a backbone selected from the group consisting of: polyamine, polysaccharide, polyvinylpyrrolidone, polyglutamicacid, polyacrylamide, polydiacetone acrylamide, polyvinyl alcohol, polyethylene glycol, polyacrylic acid, chitosan, dextrin and mixtures of any of the foregoing; and co-polymers of any of the foregoing.

14. The process according to claim 1, wherein the reagent further comprises an effective amount of an organothiophosphorus compound.

15. The process according to claim 14, wherein the organothiophosphorus compound is selected from the group consisting of: organodithiophosphinic acid, organodithiophosphonic acid, organodithiophosphoric acid, organomonothiophosphinic acid, organomonothiophosphonic acid, organomonothiophosphoric acid, their corresponding salts in the form of sodium, ammonium, or potassium, and mixtures thereof.

16. The process according to claim 15, wherein the organothiophosphorus compound comprises organodithiophosphinic acid or corresponding salts thereof; or organodithiophosphoric acid or corresponding salts thereof.

17. The process according to claim 16, wherein the organodithiophosphinic acid is a dialkyldithiophosphinic acid, and the organodithiophosphoric acid is a dialkyldithiophosphoric acid.

18. The process according to claim 1, wherein the phosphoric acid mixture further comprises an adsorbent agent.

19. The process according to claim 18, wherein the adsorbent agent is calcium sulfate solid particles.

20. (canceled)

21. (canceled)

22. The process according to claim 1, wherein the phosphoric acid mixture has a concentration of P₂O₅ from 3 weight % to 70 weight %, based on the total weight of the mixture.

23. (canceled)

24. (canceled)

25. The process according to claim 1, wherein the process further comprises a step of separating the phosphoric acid mixture.

26. The process according to claim 25, wherein the separating step further comprises flocculation.

27. The process according to claim 25, wherein the separating step further comprises filtration.

28. The process according to claim 25, wherein the separating step further comprises skimming.

29. A reagent for removing heavy metal ions from a phosphoric acid mixture comprising
(a) a heavy metal chelating agent comprising a plurality of sulfur groups; and
(b) an organothiophosphorus compound comprising an organodithiophosphinic acid or corresponding salts thereof; or organodithiophosphoric acid or corresponding salts thereof,
wherein the heavy metal chelating agent having a plurality of sulfur groups comprises a member selected from the group consisting of:
(i) 2,5-dimercapto-1,3,4-thiadiazole; 2,5-dimercapto-1,3,4-thiadiazole dipotassium salt; and 5-mercapto-3-phenyl-1,3,4-thiodiazole-2(3H)-thione potassium salt;
(ii) 2,3-dimercapto-1-propanol; 1,2-dithioethane; 1,3-dithiopropane; benzene-1,2-dithiol; 1,3-dimercapto-2-propanol; and 1,2,3-tri-mercaptopropane;
(iii) a polymer as defined by claim 1; and
(iv) mixtures of any of the foregoing.

30. (canceled)

31. The reagent according to claim 29, wherein the heavy metal chelating agent having a plurality of sulfur groups is 2,3-dimercapto-1-propanol.

32. The reagent according to claim 29, wherein the heavy metal chelating agent having a plurality of sulfur groups is 2,5-dimercapto-1,3,4-thiadiazole dipotassium salt.
